(19) United States
(12) Patent Application Publication
(10) Pub. No.: US 2008/0205200 A1
(43) Pub. Date: Aug. 28, 2008

(54) Transmission switching mechanism

(75) Inventors: Manuel Spode, La Chaux-de-Fonds (CH); Laurent Besse, Villers-le-Lac (FR); Beranger Reynard, Grand Combe Chateleu (FR); Patrick Lete, Valdahon (FR)

Correspondence Address: YOUNG & THOMPSON, 209 Madison Street, Suite 500, ALEXANDRIA, VA, 22314, US

(73) Assignee: MAURICE LACROIX S.A., SAIGNELEGIER (CH)

(21) Appl. No.: 12/071,001

(22) Filed: Feb. 14, 2008

(30) Foreign Application Priority Data
Feb. 14, 2007 (EP) 07003114.1

(51) Int. Cl. G04B 17/00; G04B 27/04; G04B 19/02

(52) U.S. Cl. 368/172; 368/191; 368/220

(57) ABSTRACT

A gear shifting mechanism intended to be integrated into an horological movement includes a gear pinion rotated by a first wheel of the movement, an element holding a first fly-back heart freely mounted on the gear pinion, and rotated by the first wheel or by a second wheel of the movement. A second fly-back heart is attached to the gear pinion, a gear wheel is mounted freely rotating around the gear pinion and holds a first hammer or also a second hammer pretensioned against the first heart or also the second heart by a first pretensioning spring or also a second pretensioning spring, and a shift wheel being rotatably mounted on the periphery of the gear wheel (4.6) holds a first cam or also a second cam.

The present invention relates to a transmission switching or shifting mechanism intended to be integrated into an horological movement and including a transmission or gear pinion rotated by a first wheel of said movement, so that a first set of information may be displayed, as well as an horological movement and a timepiece including such a mechanism.

In horology, and notably in the context of mechanical wristwatches, numerous applications exist where it would be desirable to indicate plural data with a minimum number of indicator means. In a chronograph, for instance, it is known to use a first set of hands to indicate current time, and a second set of hands to indicate chronographed time, while these hands are found, respectively, above a main dial and above an auxiliary dial that normally is smaller. This poses the risk of disturbing a reading of the dials. In certain watches, therefore, the second set of hands consists of fly-back hands arranged underneath the first set of hands, so that they may be hidden while the watch is functioning normally, and the hands for chronographed time are not used. Yet a corresponding watch needs a complicated mechanism controlling the two sets of hands. Problems of the same kind arise when other information such as the date, the power reserve, etc. are to be displayed. The present invention then seeks to propose a simple and efficient solution for the display of plural data with the aid of a minimum number of indicator means, notably hands.

To this end, the gear shifting mechanism according to the present invention is distinguished by the characteristics listed in claim 1 and/or in the dependent claims, and notably by including an element holding a first fly-back heart, this element being freely mounted on the gear or transmission pinion of the mechanism and rotated by said first wheel or by a second wheel of the movement, so that second information may be displayed, a second fly-back heart being attached to said gear pinion, a gear or transmission wheel being mounted freely rotating around said gear or transmission pinion and holding a first hammer and a second hammer, respectively, that are pretensioned against the first and second hearts, respectively, by a first and a second pretensioning spring, respectively, a shift wheel being rotatably mounted on the periphery of the gear wheel and holding a first cam and a second cam, respectively, which act upon said first and said second hammers, respectively, so as to break in alternation the contact between the first hammer and first heart and between the second hammer and second heart, respectively, in order to shift or switch the position of said gear or transmission wheel in accordance with the first and second sets of information, respectively, that are to be displayed, an intermediate control wheel being mounted freely rotating around said gear pinion and engaged with said shift or switch wheel, said intermediate control wheel being attached to a control wheel that can be rotated in a controlled way via a control mechanism of the gear or transmission mechanism.

By virtue of these measures, it is possible with a single hand or single set of hands, respectively, to display at least two different sets of information, it being possible to shift or switch the display means between at least two states that correspond to these sets of information, with the aid of the mechanism according to the present invention. The user will then not be disturbed by other indicator elements while reading the information being displayed. Moreover, the mechanism envisaged is simple and efficient. In addition, the display change may be accomplished at any time as desired by the user.

Other advantages will become apparent from the characteristics expressed in the dependent claims and in the description presenting hereinafter the invention in greater detail.

The annexed drawings represent by way of example one embodiment of the invention.

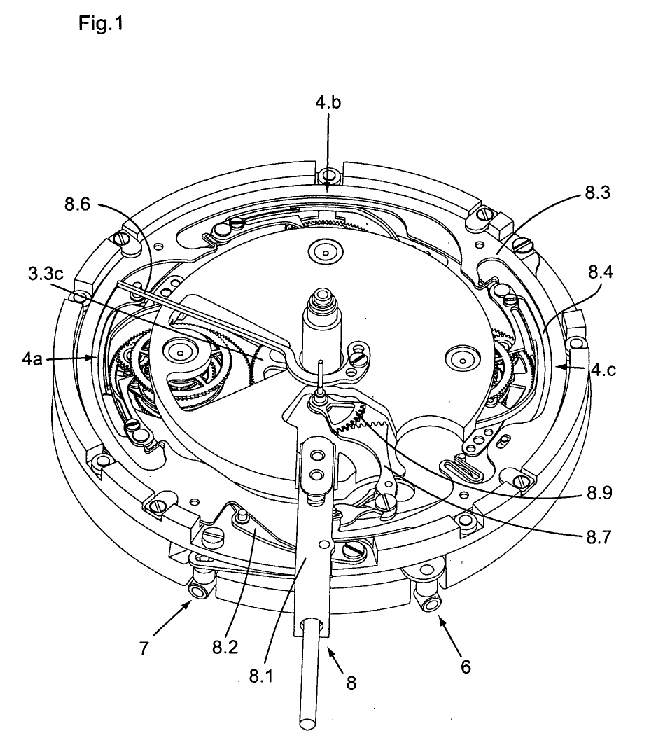

FIG. 1 shows a perspective view of a chronograph movement including a gear shifting or transmission switch mechanism according to the present invention, the dial and other elements having been omitted in order to allow certain parts of the movement to be seen that are described in greater detail hereinafter.

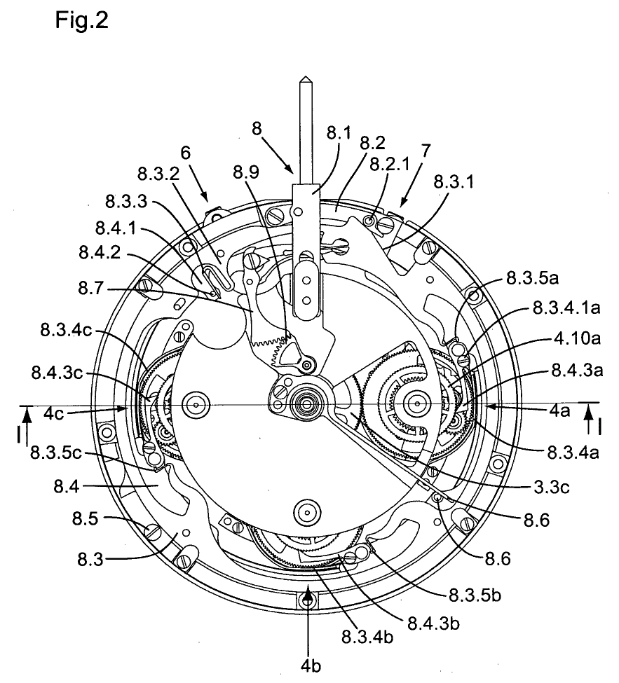

FIG. 2 is a top view of the chronograph represented in FIG. 1, making it possible at the same time to illustrate the control mechanism that cooperates with the shift mechanism integrated into a gear shifting mechanism according to the present invention.

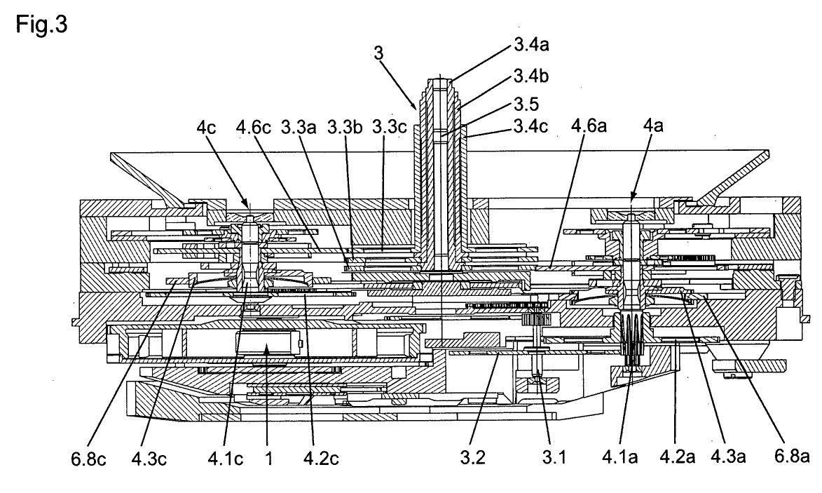

FIG. 3 is a transverse section along line I-I indicated in FIG. 2.

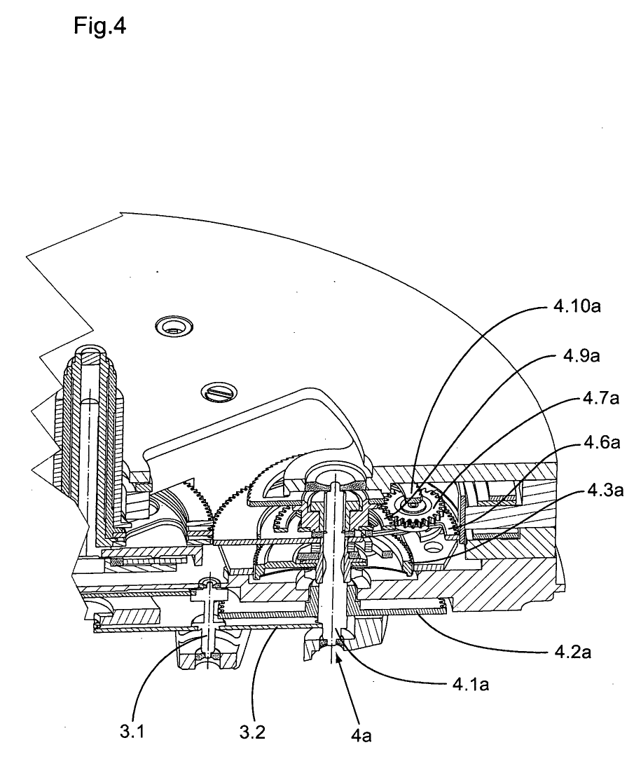

FIG. 4 represents an enlarged perspective view of this section showing more particularly the gear mechanism of the seconds wheel and pinion.

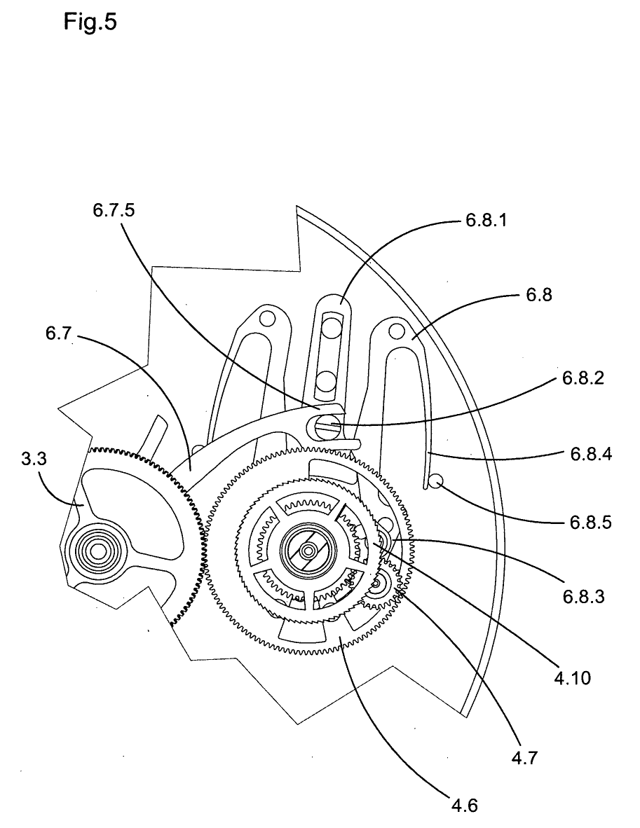

FIG. 5 is a top view of said gear mechanism of the seconds wheel and pinion.

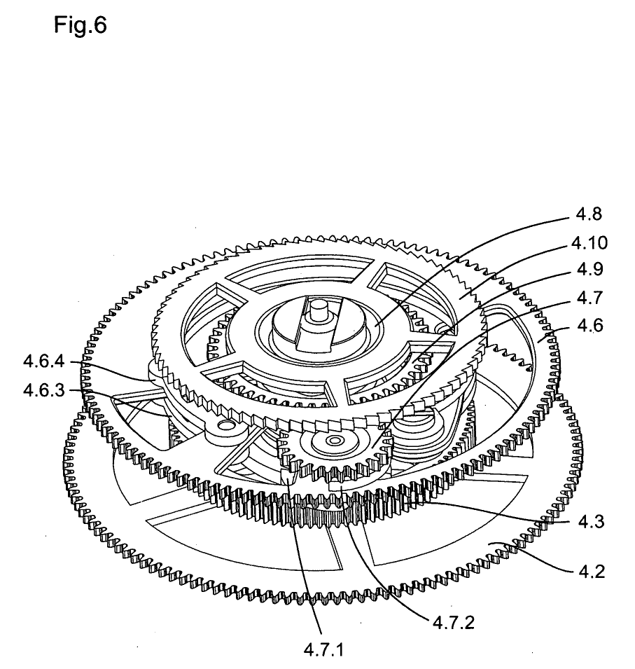

FIG. 6 shows a perspective view of the gear mechanism of the hours wheel and pinion in isolation from the other components of the chronograph movement.

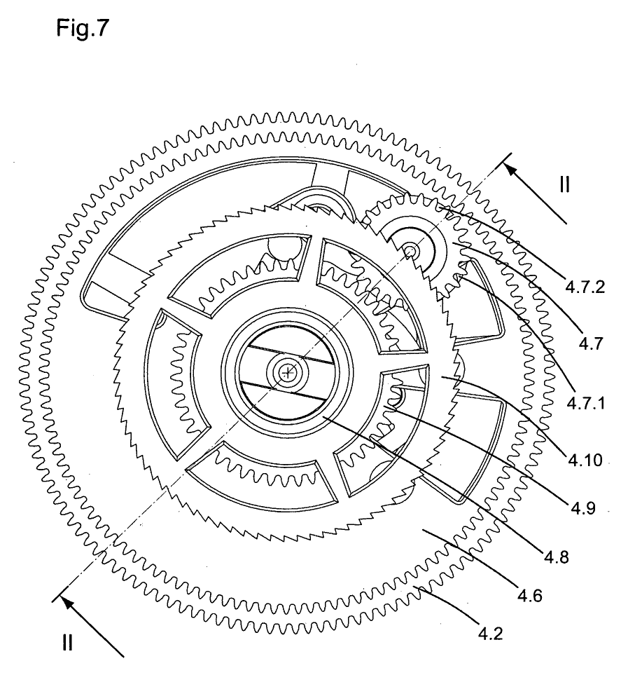

FIG. 7 represents a top view of the mechanism of FIG. 6.

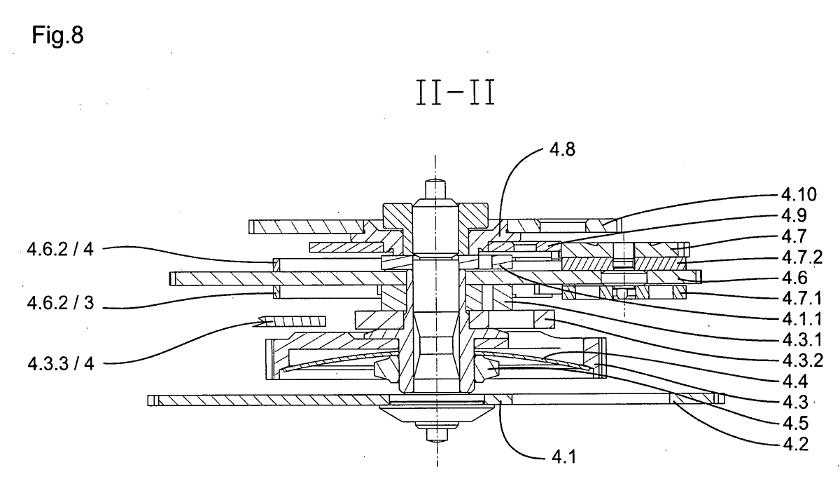

FIG. 8 is a transverse section of said mechanism along the line II-II in FIG. 7.

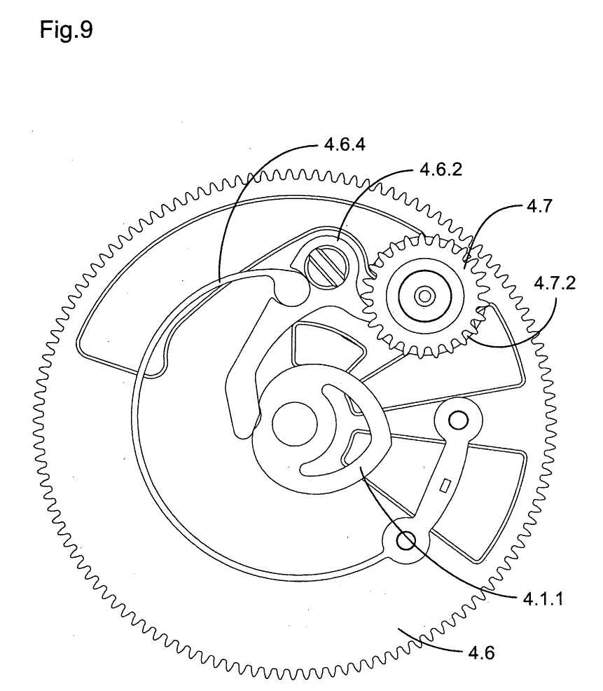

FIG. 9 is a top view showing in greater detail certain parts of the shift mechanism integrated into a gear mechanism according to the present invention.

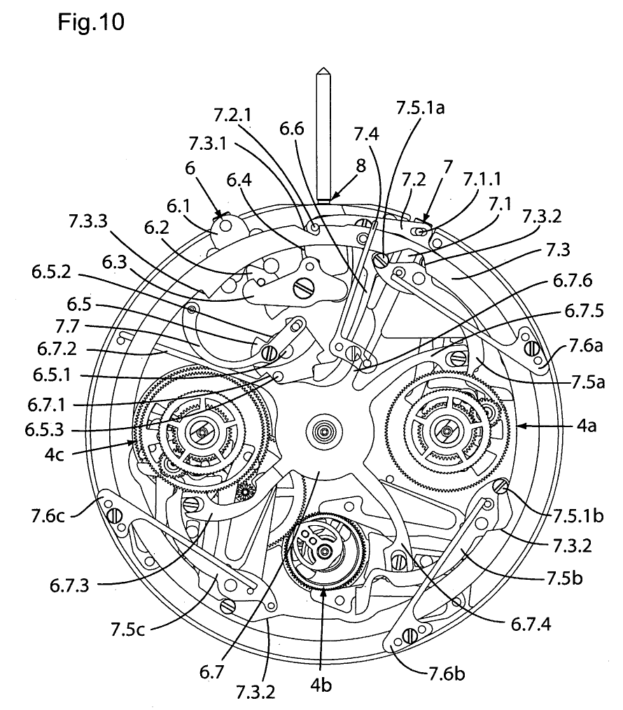

FIG. 10 shows a top view of the chronograph with certain bridges, wheels, and other elements omitted in order to illustrate the control mechanism of the chronograph.

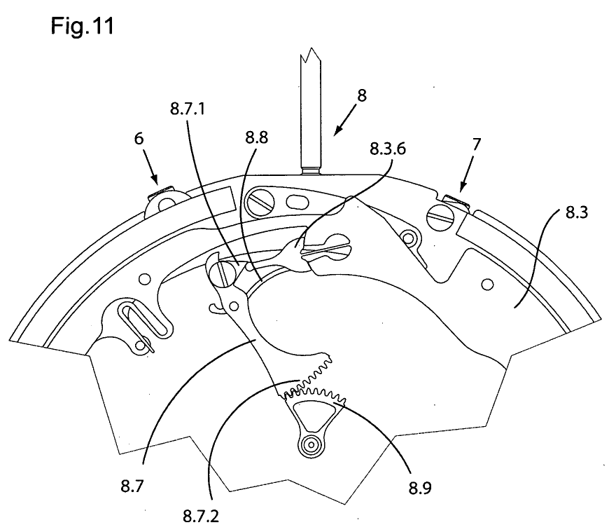

FIG. 11 is a top view of a detail of FIG. 2 showing more precisely the mechanism used for indicating the operating mode of the gear mechanism.

The invention will now be described in detail while referring to the attached drawings illustrating schematically and by way of example one embodiment of the invention.

While referring to FIG. 1 that shows a chronograph movement, it must at first be noticed that this embodiment mainly serves to illustrate in a detailed way the principle of a gear shifting mechanism according to the present invention. However, this mechanism is not limited to its application in a chronograph but may perfectly well be used in other horological applications such as indication of the date, indication of time in another time zone, indication of the power reserve, indication of diving depth in a diving watch, etc., as will be explained in greater detail in the description that follows.

In FIGS. 1 and 2, the dial and other elements of the chronograph's top part are not represented in order to allow certain segments inside the movement to be seen that will be described in greater detail hereinbelow. FIG. 3 shows the entire chronograph in transverse section along the line I-I indicated in FIG. 2.

The chronograph represented in FIGS. 1 through 3, or generally a timepiece including a gear mechanism according to the present invention, is equipped with a driving organ 1 and a regulating organ 2. The driving organ 1 may consist of a barrel spring, the regulating organ 2 may consist of a balance cooperating with the corresponding escapement, as known in the context of mechanical timepieces, and notably complicated timepieces, and illustrated in part in the attached figures. Yet instead of these organs, it is quite possible for instance to use an electronic energy source and a quartz, or an electronic and mechanical combination. As these organs 1, 2 do not constitute part of the invention, they will not be described in greater detail here.

In fact, it will be sufficient here to state that the force derived from the driving organ 1 is transmitted to a display gear train 3 including a single set of indicator means, preferably a single set of hands. In the present case, this force is at first transmitted to a third-wheel pinion 3.1, as will be apparent from FIG. 3. A third wheel 3.2 attached to said pinion 3.1 then transmits this force to a shifting gear mechanism 4 according to the present invention, more particularly to a seconds gear train 4a meshed with a seconds gear pinion 4.1a. This pinion 4.1a holds a seconds base wheel 4.2a linked with the escapement, or generally with the regulating organ 2, so as to define the rotating frequency of this wheel and pinion. Moreover, said seconds gear pinion 4.1a also holds a seconds gear wheel 4.6a meshed with a seconds indicator wheel 3.3a. This wheel 3.3a is mounted so that it may rotate around an integral peg 3.5 situated preferably in the middle of the horological movement, and attached to the second pipe 3.4a holding a seconds hand not illustrated in the figures. In addition, and as can be seen more particularly from FIGS. 1 to 3, a minute pipe 3.4b and an hour pipe 3.4c are mounted—in the case that is represented in the figures—coaxially and so as to be able to rotate around the second pipe 3.4a, and these pipes 3.4b and 3.4c each hold an indicator wheel, viz., a minutes indicator wheel 3.3b and an hours indicator wheel 3.3c, respectively, as well as a minutes hand and an hours hand, respectively. It is quite obvious that any other placement of the current display is possible, for instance an eccentric configuration.

So as to make the description of the display gear train 3 represented in FIGS. 1 to 3 complete, it must also be pointed out that in order to rotate the minutes indicator wheel 3.3b and the hours indicator wheel 3.3c, or the corresponding hands, respectively, the chronograph includes a minutes gear mechanism 4b as well as an hours gear mechanism 4c in addition to the seconds gear mechanism 4a. Like the seconds gear mechanism 4a, these mechanisms 4b and 4c are laterally arranged around the display wheel and pinion, as for instance illustrated in FIGS. 1 and 2, so that their minutes gear wheel 4.6b or hours gear wheel 4.6c may mesh with said minutes indicator wheel 3.3b and hours indicator wheel 3.3c of the display wheel and pinion, analogously to the meshing described above for the seconds gear wheel 4.6a with the seconds indicator wheel 3.3a. As to the drive needed for the minutes gear mechanism 4b and the hours gear mechanism 4c, and more particularly the gear pinions of the minutes, 4.1b, and hours, 4.1c, respectively, it should be pointed out that this can be realised in any way known to the specialist, and constitutes part of the conventional watchmakers' art.

The three gear mechanisms 4a, 4b, 4c included in the chronograph illustrated in FIGS. 1 to 4 have in fact almost identical structures, but the fact that this device includes, a gear mechanism 4 according to the present invention that has three units is merely a matter of the instant application. It could equally well just have a seconds gear mechanism and a minutes gear mechanism, for example. For certain other applications just one such mechanism could suffice, as will become clearer in the description that follows. For this reason, the detailed structure of such a gear mechanism 4 will in the following be explained by way of the example given by the hours gear mechanism 4c illustrated in FIGS. 1 to 3. In what follows, suffixes a, b, c as well as nomenclature details that say whether the seconds, minutes, or hours wheel or pinion are being considered, will no longer be given for the reasons just mentioned, at least when talking about the gear mechanisms.

It remains to be stated in this context that in the present application, the unique set of indicator means mentioned in the introduction is formed by the three hands of the seconds, minutes, and hours held by pipes of the seconds 3.4a, the minutes 3.4b, and the hours 3.4c of the display wheel and pinion. It will also become clearer in what follows that this set could equally well consist of just a single hand, for example, or of indicator means of a different type such as a display disc.

Reference will now be made more particularly to the series of FIGS. 6 to 9 in order to describe in detail the structure of a gear mechanism 4 according to the present invention. It has already been mentioned hereinabove that such a mechanism 4 first of all includes a gear pinion 4.1 forming the axis of rotation of the mechanism and holding said base wheel 4.2 which, in the example of the seconds gear mechanism, cooperates with the escapement. Normally, the gear pinion 4.1 will then be driven somehow or other by the driving organ 1 and the regulating organ 2 of the horological movement, in such a way that the information concerning some unit of current time, e.g., seconds, minutes, or hours, will be transmitted to the display gear train 3, except in specific applications that will be mentioned further down in the text.

In the application to a chronograph illustrated in the figures, coupling means are mounted above the base wheel 4.1, these means including on the one hand a clutch disc 4.3 mounted freely rotating around the gear pinion 4.1, and on the other hand an integral adjusting ring 4.5 surrounding the pinion 4.1 and compressing a friction spring 4.4 placed between this ring 4.5 and said clutch disc 4.3 in the axial direction of pinion 4.1. Since this disc 4.3 cannot be shifted axially, it will normally follow gear pinion 4.1 in its rotation owing to the friction coupling realised through friction spring 4.4. It follows more particularly from FIG. 5 that clutch disc 4.3 may to the contrary also be locked against all rotation, e.g., with the aid of a clamp that embraces it and that cooperates when shut with external fluting present on the periphery of disc 4.3. In this example, pinion 4.1 continues to rotate while disc 4.3 is stopped. The control mechanism of said clamp will be described elsewhere in what follows.

It should also be noted that on its upper side, clutch disc 4.3 holds a zero-resetting heart 4.3.2 as well as a first fly-back heart 4.3.1 that in this application serves as heart of chronographed time and sits on the lower side of said gear wheel 4.6 already mentioned hereinabove. These two hearts are attached to disc 4.3, for instance with the aid of a pin, in such a way that the hearts are rotated together with clutch disc 4.3. Moreover, a second fly-back heart 4.1.1 that in this application serves as heart of the current time sits on the upper side of gear wheel 4.6. This second fly-back heart 4.1.1 is attached to gear pinion 4.1, and hence always follows it in its rotation, contrary to the first fly-back heart 4.3.1 that can be disconnected with the aid of the clamp mentioned hereinabove.

Moreover, above said coupling means and between the first and second fly-back hearts, 4.3.1 and 4.1.1, a gear wheel and pinion is mounted that includes more particularly said gear wheel 4.6 which in the chronograph application as illustrated in the figures is engaged with one of the indicator wheels 3.3. This gear wheel 4.6 is also mounted freely rotating around gear pinion 4.1, and holds a first hammer 4.6.1 and a second hammer 4.6.2 on its lower and upper sides, respectively. These hammers are pivoted on gear wheel 4.6, and serve as feelers for said first and second fly-back hearts, 4.3.1 and 4.1.1, respectively. This configuration is illustrated in the section of FIG. 8 and in the top view of FIG. 9 showing gear wheel 4.6 together with the second fly-back heart 4.1.1 and the second hammer 4.6.2 pretensioned against heart 4.1.1 by a second pretensioning spring 4.6.4 attached to gear wheel 4.6. The first hammer 4.6.1 is pretensioned in an analogous way by a first pretensioning spring 4.6.3 against the first fly-back heart 4.3.1.

In this way a shift mechanism is mounted onto gear wheel 4.6 so as to guarantee that at any one time only one hammer will be in contact with one of the hearts 4.3.1, 4.1.1. This shift mechanism comprises a shift wheel 4.7 mounted so that it is able to rotate around an axis of rotation that can be found on the periphery of gear wheel 4.6, this axis being parallel to gear pinion 4.1. The shift wheel 4.7 includes a first cam 4.7.1 and a second cam 4.7.2 that can be found in the same respective plane as the first hammer 4.6.1 and the second hammer 4.6.2 mentioned above, on the lower side and upper sides, respectively, of gear wheel 4.6. Disregarding other alternative forms, these two cams 4.7.1 and 4.7.2 can essentially be in the shape of straight rods fastened in their middle to the axis of shift wheel 4.7 and making a right angle between each other, so that in any given position of shift wheel 4.7, only one end of one of the cams 4.7.1, 4.7.2 pushes against one of the hammers 4.6.1, 4.6.2—for example the first cam 4.7.1 against the first hammer 4.6.1. Cam 4.7.1 then separates the first hammer 4.6.1 from the first fly-back heart 4.3.1 against the effect of the pretensioning spring 4.6.3, this heart being the heart of chronographed time in the application being considered, while the second cam 4.7.2 does not act upon the second hammer 4.6.2, which under the effect of its pretensioning spring 4.6.2 will then remain in contact with the second fly-back heart 4.1.1, here serving as the heart of the current time. This configuration is illustrated in FIG. 9. A rotation of shift wheel 4.7 through an angle of 90° will bring about, on the one hand that the first cam 4.7.1 no longer pushes against the first hammer 4.6.1, which for this reason will then be pretensioned by its pretensioning spring 4.6.3 against the first fly-back heart 4.3.1, and on the other hand that one end of the second cam 4.7.2 pushes against the second hammer 4.6.2, thus breaking its contact with the second fly-back heart 4.6.2. Another rotation through 90° reproduces the earlier constellation, this time with the other end of the first cam 4.7.1 pushing against the first hammer 4.6.1, and so on.

In order to make it possible to control this shift wheel 4.7 with its two cams 4.7.1 and 4.7.2 being fastened at a right angle, the shifting gear mechanism according to the present invention also includes an intermediate control wheel 4.9 that is attached to a control stud 4.8 mounted freely rotating around gear pinion 4.1, on the upper side of gear wheel 4.6. The intermediate control wheel 4.9 is engaged with shift wheel 4.7, and can make it rotate. In addition, a control wheel 4.10 is attached to control stud 4.8, and makes it possible via a control mechanism to be described further below in the description, that the double wheel formed by control wheel 4.10 and the intermediate control wheel 4.9, both attached to control stud 4.8, will move shift wheel 4.7 so as to change its position relative to gear wheel 4.6, thus commutating the hammers 4.6.1, 4.6.2 pushing against their hearts 4.3.1, 4.1.1, respectively. This relative position of shift wheel 4.7 could by the way be protected against any unintentional rotation by an elastic locking element or any other adequate means, for instance a jumper spring attached to a bridge and pushing against control wheel 4.10, or even a jumper spring attached to the gear wheel and pushing against shift wheel 4.7.

The above description of the structure of the gear mechanism will facilitate an understanding of its operation. In the application presented in the figures, the gear pinion actually is always driven by the horological movement, its rotation being transmitted via gear wheel 4.6 to the indicator Wheel 3.3 when the second hammer 4.6.2 is in contact with the second heart 4.1.1, which is the heart of the current time, while no contact exists between the first hammer 4.6.1 and the first heart 4.3.1. Thus, current time is displayed by the unique set of hands. If the position of shift wheel 4.7 is changed by a rotation through 90°, then the contact between the second hammer 4.6.2 and the second heart 4.1.1 is broken while the first hammer 4.6.1 under the effect of pretensioning spring 4.6.3 strikes against the first fly-back heart 4.3.1, which is the heart of chronographed time. The gear wheel then rotates until hammer 4.6.1 has found its stable position on heart 4.3.1, which corresponds to the chronographed time. The single set of hands then displays the chronographed time, since the same operation is accomplished simultaneously with the three wheels and pinions: of the seconds 4a, the minutes 4b, and the hours 4c. By modifying the position of control wheel 4.10 or shift wheel 4.7, respectively, the user may then choose at any time what information will be displayed on the dial by the one and only set of hands.

It must be added here that the specific application of a gear mechanism 4 according to the present invention in a chronograph has several consequences. On the one hand, such a chronograph includes three such mechanisms in order to be able to display the seconds, minutes, and hours of chronographed time, these three mechanisms being positioned laterally around the display wheel and pinion, as already mentioned hereinabove, thus admitting an easy meshing of each gear wheel 4a, 4b, 4c with the corresponding indicator wheel 3.3a, 3.3b, 3.3c. On the other hand, considering the arrangement of each individual mechanism, a structure specifically adapted to that application is found in its segment comprising the first fly-back heart, i.e., coupling means. In fact, since the chronographed time is a quantity that is different from the current time but is merely offset relative to it, it will not be necessary that the coupling means representing the chronographed time be driven separately. They may then be coupled to the gear pinion representing the current time, just as described hereinabove, with the aid of a friction clutch. Finally, apart from the first fly-back heart for the indication of chronographed time, the coupling means include another heart, viz., the zero-resetting heart 4.3.2. This is positioned in such a way on clutch disc 4.3 that a corresponding zero-resetting hammer 4.3.3 that for instance is attached to the chronograph frame, once released could strike the periphery of said heart 4.3.2 so as to rotate clutch disc 4.3 until the corresponding hand is reset to the 12-noon position. It is clear in this context that in all actions mentioned hereinabove that imply a rotation of clutch disc 4.3, said clamp embracing this disc is spread open simultaneously in order to release it, which will be described further on in context with the chronograph's control mechanism.

When abstracting from the specific application to a chronograph illustrated in the figures, it is clear, too, that in general the shifting of the gear mechanism according to the present invention is realised via shift wheel 4.7 and the two corresponding cams 4.7.1 and 4.7.1, with the aid of two hearts 4.3.1, 4.1.1 attached to elements each representing a quantity to the displayed, and of two corresponding hammers 4.6.1, 4.6.2 attached to gearwheel 4.6, one of them sensing the heart the information of which should be displayed. It will then be possible to display as it were all the information normally available within a timepiece, with the aid of a mechanism according to the present invention, by linking an element holding a corresponding heart with the wheel and pinion representing the desired information. If it is for instance either the date or the current time that should be displayed, then clutch disc 4.3 may be replaced by a calendar wheel mounted freely rotating around gear pinion 4.1, and driven in known manner by a calendar wheel and pinion. The single heart attached to this calendar wheel—since a zero-resetting heart will obviously not be necessary for this application—would then represent the date while gear wheel 4.6 would bring back the corresponding indicator wheel to a position that is appropriate for the hand that is attached to it, to indicate the date, if its corresponding hammer was shifted so as to sense this heart. It will then be clear to the specialist that this principle may be applied to a large number of other applications in order to display as elected, either set of information with a single hand or a single set of hands, or with other indicator means such as display discs. Further examples to be mentioned are the indication of time in another time zone, the sidereal time, a phase of the moon, or even the diving depth. In this last case, the element or wheel holding the heart that corresponds to this information should then be driven for example by the depth detector, again in such a way as known to the horological specialist. Various combinations of these sets of information can be imagined that do not necessarily imply an indication of the current time by the single set of hands or even by the single hand, for example, the indication of either the date or the diving depth, depending on the position of shift wheel 4.7 relative to gear wheel 4.6. It will be obvious that the dial of the timepiece would be arranged in a corresponding way.

It finally remains to mention that one can equally well envisage mounting more than two fly-back hearts close to gear wheel 4.6, which would then be equipped with one more hammer with corresponding pretensioning spring, while shift wheel 4.7 would be equipped with one more cam, and the three cams would then be separated by 120°, rather than by 180° as in the case of two cams. The whole will function according to the same principle as described hereinabove, but includes an additional working plane as compared to the two planes of the two hammers or fly-back hearts mentioned above. In this case the additional fly-back heart would be attached to another element that is mounted freely rotating around the gear pinion, this element being connected to the wheel and pinion representing the additional information to be displayed.

Turning once more to the specific application illustrated in the figures, the control mechanism of the chronograph will now be described in greater detail in what follows while referring more particularly to FIG. 10 as well as to FIG. 5.

The timepiece into which the chronograph illustrated in the figures ought to be integrated preferably has two push pieces 6, 7 as well as a crown with an integrated third push piece 8. These elements are mounted in conventional fashion into the case of the timepiece, and do not appear in the figures, while FIG. 10 to the contrary shows the elements acted upon by these push pieces.

A first or start-stop button 6 of the chronograph first acts upon a start-stop corrector 6.1 that can be shifted axially toward the centre of the movement while it is guided by four pins laterally surrounding it. When corrector 6.1 is shifted inward, it swings a first lever 6.2 that is pivoting around a pin not illustrated, while the end of the first lever 6.2 that points from the chronograph outward is engaged in a triangular notch of corrector 6.1. The first lever 6.2 also holds a pin engaging a second lever 6.3 pretensioned by a corresponding pretensioning spring 6.4, so as to push the first lever 6.2 as well as the start-stop corrector 6.1, or the entire start-stop button 6, outward after its manual actuation. Via the end of first lever 6.2 that is oriented toward the interior of the chronograph, such a first actuation produces a clockwise rotation of a navette 6.5 about its centre of rotation 6.5.1, since this end of first lever 6.2 cooperates with a first plane situated in a lateral notch 6.5.2 of navette 6.5. The navette 6.5 is then indexed in this position (not illustrated) with the aid of a jumper spring 6.6 of the navette that cooperates with one of the two positioning notches formed on navette 6.5; the other positioning notch indexes the navette in cooperation with said jumper spring 6.6 of the navette in its initial position illustrated in FIG. 10. Clockwise rotation of the navette 6.5 causes counterclockwise rotation of a lever that in what follows will be called ‘octopus’ 6.7, and that is pivoting around the axis of the chronograph's display wheel and pinion. In fact, this octopus 6.7 includes an inclined plane 6.7.1 acted upon by a pin 6.5.3 that is mounted on navette 6.5, the octopus being pretensioned by a spring arm 6.7.2 of the octopus against this pin 6.5.3. In the initial position shown in FIG. 10, which is the chronograph's stop position, octopus 6.7 is then pushed against pin 6.5.3 of navette 6.5 while a clockwise rotation of the navette via the effect of its pin 6.5.3 on the inclined plane 6.7.1 of octopus 6.7 will result in a counterclockwise rotation of octopus 6.7, the octopus then taking up its second stable position, which is the chronograph's start position. The naming of these positions is founded insofar as octopus 6.7 has another three arms 6.7.3, 6.7.4, 6.7.5, each of them engaged with a pin 6.8.2 sitting on a clamp 6.8 already mentioned hereinabove, and each of the three clamps 6.8a, 6.8b, 6.8c allowing the corresponding clutch disc 4.3 of the seconds gear mechanism 4a, the minutes gear mechanism 4b, and the hours gear mechanism 4c to be locked when the clamp is in its closed state, or to be released when the clamp is in its opened state. FIG. 5 shows in greater detail that each clamp 6.8 may in fact slide forward and backward while it is guided by two pins attached to the chronograph frame, and traverses a guide bearing in a central arm 6.8.1 of clamp 6.8. In the chronograph's stop position as described above, each clamp 6.8 thus is in its forward position relative to the corresponding clutch disc 4.3, while the front ends 6.8.3 of clamp 6.8 embracing this disc 4.3 are tightened with the aid of its rear spring ends 6.8.4 that cooperate with pins 6.8.5 also positioned on the chronograph frame. In said starting position of the chronograph, the octopus is in a position where it has turned counterclockwise, its arms 6.7.3, 6.7.4, 6.7.5 then placing each clamp 6.8 in its rear position relative to the corresponding clutch disc 4.3, the clamps in this case being opened. The friction clutch of clutch disc 4.3 can then pull this disc along, and the chronograph begins counting the chronographed time. Via an effect of said end of first lever 6.2 that points toward the inside of the chronograph, onto a second plane situated in the lateral notch 6.5.2 of navette 6.5, a second pressing of the first push piece 6 finally causes a counterclockwise rotation of navette 6.5 around its centre of rotation 6.5.1 or, because of the effect of its spring arm 6.7.2 in this direction, a clockwise rotation of octopus 6.7. Each clamp 6.8 is then brought back into its forward position, and the clutch discs are once more locked, which stops the chronograph measuring the chronographed time.

A second or zero-resetting button 7 of the chronograph acts upon a zero-resetting corrector 7.1 that can be axially displaced toward the centre of the movement. At its end pointing toward the inside of the chronograph, it has an inclined plane that cooperates with a corresponding inclined plane of a fifth arm 6.7.6 of octopus 6.7 so that this is rotated counterclockwise. By pressing the second push piece 7, the clutch discs 4.3 are then released as described above, but this time this action is initiated by the second push piece 7. As soon as push piece 7 is released, the octopus returns to its initial position, and discs 4.3 are locked once again. At its end pointing from the chronograph outward, said zero-resetting corrector 7.1 holds a pin 7.1.1 engaged in an opening formed in one end of a corrector lever 7.2 that is pivoting around a screw attached to a bridge of the chronograph. The other end of this corrector lever 7.2 holds a pin 7.2.1 that normally, i.e., so long as the second push piece 7 is not manually pressed, is engaged in a locking notch 7.3.1 in a zero-resetting ring 7.3, in such a way that it locks this ring against all counterclockwise rotation, that is, in the direction in which it is pretensioned with the aid of a pretensioning spring 7.4 pushing against a corresponding pin positioned on this ring 7.3. Once the second zero-resetting button 7 is pressed, the zero-resetting ring is released by disengagement of said pin 7.2.1 from the locking notch 7.3.1, and driven by its pretensioning spring 7.4 makes a counterclockwise rotation through a given angle. On its inner circumference, this zero-resetting ring 7.3 further includes three control notches 7.3.2 each located so as to face one zero-resetting hammer 7.5. Each zero-resetting hammer 7.5a, 7.5b, 7.5c is pivoting on a bridge of the chronograph, and is situated in the same working plane as the corresponding zero-resetting hearts 4.3.2a, 4.3.2b, 4.3.2c mentioned earlier in the description. Likewise, each hammer 7.5 is pretensioned against the corresponding zero-resetting heart 4.3.2 with the aid of a pretensioning spring 7.6 pushing against a corresponding pin that is attached to each hammer. The hammers 7.5 may not however come in contact with the corresponding zero-resetting heart 4.3.2 so long as the zero-resetting ring 7.3 is in its initial position, that is, so long as the second push piece has not been pressed, since an eccentric 7.5.1 mounted on each hammer 7.5 is in contact with the inner circumference of the ring 7.3 and prevents their actuation. As soon as the zero-resetting ring 7.3 has been rotated counterclockwise after pressing of the second push piece 7, the eccentrics 7.5.1 are released, since they are situated facing said control notches 7.3.2 on ring 7.3, and the hammers strike the periphery of the corresponding zero-resetting heart 4.3.2 so as to rotate it to its stable position corresponding to the 12-noon position of the hands. This zero-resetting action is possible, since the clutch discs 4.3 holding the zero-resetting hearts 4.3.2 have been released simultaneously, as described above. The eccentrics 7.5.1 can be rotated correspondingly in order to adjust the time of release of each hammer. It must yet be noticed that on its inner circumference, the zero-resetting ring 7.3 also includes a return notch 7.3.3 into which a return lever 7.7 can become engaged in order to return the ring to its initial position once the second push piece 7 has been pressed. It is apparent from FIG. 10 that the return lever 7.7 is mounted onto navette 6.5, and comes in contact with said return notch 7.3.3 of ring 7.3 when this ring is in its rotated position after pressing of the second zero-resetting button 7 and the first or start-stop button of the chronograph has been pressed in its start function as described above while said navette 6.5 then is driven in the clockwise direction, the consequence being that the return lever returns the zero-resetting ring to its initial position against the effect of pretensioning spring 7.4. The two push pieces 6, 7 then allow the known functions of a chronograph to be controlled.

It finally remains to describe the control mechanism of the gear mechanism as well as its mechanism of indicating the operating mode, which will be done in what follows while referring to FIGS. 2 and 11, respectively.

The control mechanism that allows the gear mechanism to be shifted cooperates with the shift mechanism that is integrated into a shifting gear mechanism according to the present invention, and more particularly with the shift wheel 4.7 or the control wheel 4.10 mentioned above. A timepiece equipped with such a mechanism normally includes a crown, not illustrated, that is coupled with a winding stem in order to accomplish the conventional functions such as winding and setting of the indicator means. In addition, a third or shift button 8 preferably is set up coaxially to said winding stem; it could evidently be placed elsewhere. This third push piece 8 is linked to a shift element 8.1 that can be moved axially, and in turn allows a shift lever 8.2 that at its working end holds an actuating pin 8.2.1, to be pivoted via a pin going through these two pieces. When the third push piece 8 is manually actuated, then this pin 8.2.1 can grip an inclined plane formed in an actuating notch 8.3.1 that is situated on the periphery of a first control ring 8.3, in such a way that this ring rotates counterclockwise through an angle that corresponds to the length of said inclined plane. The first ring 8.3 further includes an arm 8.3.2 with a spring 8.3.3 essentially Z-shaped that pushes against a pin 8.4.2 attached to an arm 8.4.1 of a second control ring 8.4 that preferably is placed underneath the first control ring 8.3, as illustrated for instance in FIG. 2. Via a rotation of the first control ring 8.3, a manual pressing of the third push piece 8 then also causes the counterclockwise rotation of the second control ring 8.4, but this ring is limited in its rotation by a limiting eccentric 8.5 attached to a bridge of the chronograph and struck by a front plane of said arm 8.4.1 of the second ring 8.4. In addition, this second ring includes three pawls 8.4.3a, 8.4.3b, 8.4.3c each situated so as to face one gear wheel and pinion 4a, 4b, 4c with which it cooperates. Actually each pawl 8.4.3 is situated in the same working plane as the control wheel 4.10 of the corresponding gear wheel and pinion, and is pretensioned against this wheel 4.10 by a pretensioning control spring 8.3.4 that could for instance be an integral part of the first control ring 8.3. Any pawl 8.4.3 will however not push against the corresponding wheel 4.10 so long as the third push piece 8 has not been pressed, because the first control ring 8.3 also includes three holding springs 8.3.5 that normally are engaged, each in one notch at the end that is situated behind each pawl 8.4.3 (when looking counterclockwise), so as to prevent the pawl from pushing against wheel 4.10. As described above, a manual pressing of the third push piece 8 then causes counterclockwise rotation of the first control ring 8.3 and of the second control ring 8.4, the movement of the second ring 8.4 being limited by said limiting eccentric 8.5 when the manual force exerted on the third push piece is sufficient, while rotation of the first ring 8.3 continues until the spring 8.3.3 on its arm 8.3.2 is completely compressed by its pushing against the pin 8.4.2 attached to the arm 8.4.1 of the second control ring 8.4. Because of this counterclockwise rotation of first ring 8.3 relative to second ring 8.4, the holding springs 8.3.5 release the pawls 8.4.3 so that they will push against the corresponding wheel 4.10 under the effect of their pretensioning control springs 8.3.4. This effect will only be produced when the manual force exerted on the third push piece 8 is sufficiently large to compress said spring 8.3.3 on the first ring 8.3 so that a relative rotation of the two rings 8.3, 8.4 is produced, thus realising an “all-or-nothing” function, in that no action is produced when the user does not correctly press the push piece. Once the pawls 8.4.3 push against the corresponding wheels 4.10 and the rings are fully displaced counterclockwise, then a return spring 8.6 pushing clockwise against a return pin 8.4.4 that is sitting on the second disc 8.4 brings the two discs to their initial position as soon as the manual force exerted on push piece 8 is relieved. Each of the pawls 8.4.3 that at this time is engaged with the corresponding control wheel 4.10 will at the same time cause this wheel to rotate, and via the intermediate control wheel 4.9 thus allow the corresponding shift wheel 4.7 to rotate through an angle of 90°, so as to commutate the positions of cams 4.7.1, 4.7.2. This control mechanism thus allows the gear mechanism according to the present invention to be shifted or commutated. It must be added that each pawl 8.4.3 further includes an eccentric 8.3.4.1 with a corresponding pin that enters into a hollow provided in the bridge that is for instance situated underneath the two rings 8.3, 8.4. This hollow has a shape adapted to guide pawls 8.3.4 when the two rings 8.3, 8.4 are at the end of their return movement, into their initial positions in which they are again engaged by holding springs 8.3.5, that is, their contact with control wheel 4.10 is once more broken.

It is obvious that the arrangement of such a control mechanism that has been described above for a gear mechanism according to the present invention, is specifically adapted to its application in a chronograph such as that illustrated in the figures. In other applications such as those recalled above, it will to the contrary not always be necessary to provide three pawls, or even the rings, which eventually could be replaced by a lever or any other appropriate element if only a single pawl has to be acted upon. Actually this control mechanism can be used in all applications in which it is necessary to accomplish the controlled rotation of at least one wheel through a predetermined angle, this rotation preferably being executed only when the driving force that could have a manual or automatic source will exceed a given value, so that a function is provided that is called “all-or-nothing”. The specific layout of the elements that hold the parts realising on the one hand a rotation, that is, the pawls and corresponding parts, and on the other hand the “all-or-nothing” function, that is, mainly the spring between the holding elements, will then depend, primarily on the comtemplated application. Such other modifications of a control mechanism that is adapted to the present invention are at any rate within the know-how of a specialist and need not be recalled in detail here.

Turning now to FIG. 11, one can see in greater detail that the device also includes a mechanism for indicating the operating mode of the gear mechanism. In fact, the first control ring 8.3 also includes a needle spring 8.3.6 sitting in a longitudinal recess on ring 8.3, this recess having an open side facing toward the inside of the ring. On each side of the opening of the recess a lateral flank is formed on ring 8.3, these lateral flanks preferably being slightly rounded and the curvature being such as to produce a lateral recess so that the needle spring 8.3.6 will be able to swing laterally, and its movement can be guided. In its forward segment toward the opening, the longitudinal recess formed in control ring 8.3 preferably also includes a shape that is adapted to limit the lateral movement of needle spring 8.3.6 via its inner walls, a possible result being that this lateral recess essentially assumes the shape of a key hole. The needle spring 8.3.6 includes a first segment forming an elastic arm that is taken up in this recess, one end of this first segment being attached to the bottom of the closed side of the longitudinal recess on ring 8.3, and its longitudinal axis being essentially parallel to the longitudinal axis of this recess. Preferably, this elastic arm, or all of the needle spring 8.3.6, may be integrally formed with said ring 8.3. In addition, the needle spring 8.3.6 includes a second segment forming a shift needle that is integrally formed on the other end of said elastic arm or attached to it. This second segment includes, on the one hand at the level of the lateral flanks on said longitudinal recess two lateral wings that are essentially triangular and have a rear segment each that in its shape corresponds to said lateral flanks, for instance a rounded shape, thus allowing needle spring 8.3.6 to perform a lateral movement—which is possible by virtue of its elastic arm as mentioned above—and to be guided by said lateral flanks situated on ring 8.3. On the other hand, at its free end the second segment of needle spring 8.3.6 includes a point, preferably rounded, that cooperates with either of the inclined planes located on an essentially triangular arm 8.7.1 that is attached coaxially with respect to the axis of rotation to an indicator lever 8.7 pivoting on a bridge of the chronograph. On the one hand, the triangular arm 8.7.1 is oriented so that its point is found essentially on the longitudinal axis of needle spring 8.3.6. On the other hand it is oriented essentially perpendicularly to the longitudinal axis of indicator lever 8.7, so that this lever on each side of the triangular arm 8.7.1 will form a plane that is perpendicular to the corresponding inclined plane, and against which needle spring 8.3.6 may push when it performs a forward motion in the direction of its longitudinal axis, laterally slightly deflected by one of said inclined planes. At its other end this lever 8.7 includes a first toothed sector 8.7.2 engaged with a second toothed sector 8.9 that is mounted so that it can rotate, on a bridge of the chronograph and holds a hand or other indicator means showing on the dial of the corresponding timepiece the mode in which the gear mechanism is currently operating, that is, showing which of the fly-back hearts 4.3.1, 4.1.1 is sensed by the hammers 4.6.1, 4.6.2 that are arranged on gear wheel 4.6, and thus what kind of information is currently displayed by the single set of indicator means.

The functioning of this indicator mechanism is readily understood in view of its structure as described above. In fact, when indicator lever 8.7 and the second toothed sector 8.9 or the hand attached to this element are in a first stable position that corresponds to display of first information by the single set of indicator means, then indicator lever 8.7 is protected against any unintentional displacement by an indicator jumper spring 8.8 that has two notches one of which receives a pin that is attached to lever 8.7. When pressing the third push piece 8, the first control ring 8.3 rotates, and needle spring 8.3.6 is pushed forward toward said triangular arm 8.7.1 while its point comes in contact with the first inclined plane of the triangular arm 8.7.1 of indicator lever 8.7, so that this inclined plane will deflect the axial forward movement of needle spring 8.3.6 laterally toward one side of the triangular arm 8.7.1. Thus, needle spring 8.3.6 pushes indicator lever 8.7 into a second stable position that corresponds to display of second information by the single set of indicator means when the manual force exerted on push piece 8 is sufficient, since at the end of each inclined plane of the triangular arm 8.7.1 one of said planes perpendicular to the corresponding inclined plane exists where needle spring 8.3.6 will abut at the end of its forward movement that is provoked by the movement of ring 8.3 that holds this needle spring. Indicator lever 8.7 will then cause the second toothed sector 8.9 including its hand or other means serving to indicate the operating mode of the gear mechanism, to follow its rotation. Indicator lever 8.7 or said indicator means are again protected in the second position by the indicator jumper spring 8.8, the pin attached to lever 8.7 now sitting in the other of the two notches present in this jumper spring 8.8. Since indicator lever 8.7 has now swung into this position from its first position, a new pressing of the third push piece 8 will produce the same effect, except that now needle spring 8.3.6 is guided by the second inclined plane of the triangular arm 8.7.1 of indicator lever 8.7 and hence returns this lever into its first position, and so on. In fact, in a given position among the two stable positions of indicator lever 8.7, the point of its triangular arm 8.7.1 is slightly deflected laterally relative to the longitudinal axis of needle spring 8.3.6 in its rest position, so as to guide the point at the free end of said spring onto the inclined plane of triangular arm 8.7.1 and allow indicator lever 8.7 to be pushed into the other stable position. The indicator mechanism then indicates at all times the mode in which the gear mechanism actually operates or which information currently is displayed by the single set of indicator means.

It is obvious in this context that apart from the application mentioned above, that is, the indication of the mode of functioning of the gear mechanism, this device can also be used for other applications. In fact, we have to do here in a general way with a bistable commutator that can be used for any application requiring two stable positions to be available. In other applications, it will thus not always be necessary for the second sector 8.9 to have a hand, or to even have two sectors, since the free end of lever 8.7 may in fact be used to cooperate with any other element able to be commutated or shifted directly or indirectly between two states. Also, ring 8.3 could eventually be replaced for instance by a lever, an arm, a rack, or any other element apt to produce an axial displacement of the needle spring that in this case will be provided on that element which, for its part, may be driven for example by a push piece, by a jumper spring or any other control organ known to the specialist in the horological context. The specific arrangement of the major elements of such a commutating means and particularly so of the element with needle spring 8.3.6, and of lever 8.7 with its triangular arm 8.7.1, may equally well be modified, for instance by rounding the point of the triangular arm 8.7.1 rather than that of the needle spring 8.3.6. Other such modifications in control means that are adapted for the present invention are also within the know-how of a specialist, and will for this reason not be presented in detail here.

In view of the above description of the device according to the present invention, the specialist will understand the advantages of this device, and particularly the fact that it is possible with a single hand or single set of hands to display at least two different sets of information, the hand or hands being able to be shifted or commutated between at least two states corresponding to these sets of information, with the aid of the gear mechanism according to the present invention. The user will thus not be disturbed by other indicator elements when reading the information displayed. In addition, the indicator means for the operating mode of the mechanism indicate to him which information is displayed on the dial of the timepiece. Besides, the mechanism contemplated is simple and efficient, and may more particularly be transposed to a number of applications in horology such as those that had been recalled in greater detail hereinabove. Also, the commutation of the operating mode of the gear mechanism and the corresponding change in display on the dial of the timepiece may be realised at any time when a user may wish to do so, the device thus enjoying a great flexibility in its use.

1. Gear shifting or transmission switching mechanism (4), intended to be integrated into an horological movement and including a gear pinion (4.1) rotated by a first wheel of said movement, so that it will represent a first set of information to be displayed, characterised in that an element (4.3) holding a first fly-back heart (4.3.1) is freely mounted on said gear pinion (4.1), and rotated by said first wheel or by a second wheel of said movement, so that it will represent a second set of information to be displayed, a second fly-back heart (4.1.1) being attached to said gear pinion (4.1), a gear wheel (4.6) being mounted freely rotating around said gear pinion (4.1) and holding a first hammer (4.6.1) and a second hammer (4.6.2), respectively, that are pretensioned against the first heart (4.3.1) and second heart (4.1.1), respectively, by a first pretensioning spring (4.6.3) and a second pretensioning spring (4.6.4), respectively, a shift wheel (4.7) being rotatably mounted on the periphery of the gear wheel (4.6) and holding a first cam (4.7.1) and a second cam (4.7.2), respectively, which act upon said first hammer (4.6.1) and second hammer (4.6.2), respectively, so as to break in alternation the contact between the first hammer (4.6.1) and first heart (4.3.1) and between the second hammer (4.6.2) and second heart (4.1.1), respectively, in order to shift the position of said gear wheel (4.6) in accordance with the first and second sets of information, respectively, that are to be displayed, an intermediate control wheel (4.9) being mounted freely rotating around said gear pinion (4.1) and engaged with said shift wheel (4.7), said intermediate control wheel (4.9) being attached to a control wheel (4.10) that can be rotated in a controlled way via a control mechanism (8) of the gear mechanism (4).

2. Mechanism according to the preceding claim 1, characterised in that said gear wheel (4.6) is situated axially between the first heart (4.3.1) and the second heart (4.1.1), and in that the first hammer (4.6.1) and second hammer (4.6.2) are arranged on the lower side and upper side, respectively, of the gear wheel (4.6).

3. Mechanism according to claim 1, characterised in that the first heart (4.3.1) and the second heart (4.1.1) are situated axially on the same side of said gear wheel (4.6), and in that the first hammer (4.6.1) and second hammer (4.6.2) are arranged on this side of the gear wheel (4.6).

4. Mechanism according to claim 1, characterised in that said element (4.3) holding a first fly-back heart (4.3.1) consists of a clutch disc mounted freely on said gear pinion (4.1) with the aid of a friction clutch, and driven by said first wheel and pinion of the horological movement so that the first heart (4.3.1) represents the chronographed time, and the second heart (4.1.1) mounted on the gear pinion (4.1) represents the current time, said clutch disc also holding a zero-resetting heart (4.3.2) making it possible for the chronographed time to be reset to zero via a zero-resetting hammer (4.3.3) adapted to strike the periphery of said zero-resetting heart (4.3.2).

5. Mechanism according to claim 1, characterised in that said element (4.3) holding a first fly-back heart (4.3.1) consists of a wheel freely mounted on said gear pinion (4.1), and driven by said second wheel and pinion of the horological movement so that the first heart (4.3.1) represents the second set of information to be displayed, and corresponding to said second wheel and pinion of the movement, while the second heart (4.1.1) mounted on the gear pinion (4.1) represents the first set of information to be displayed, and corresponding to said first wheel and pinion of the horological movement.

6. Mechanism according to claim 1, characterised in that the shift wheel (4.7) includes two cams (4.7.1, 4.7.2) forming a right angle relative to each other, and having two ends each that act in alternation on said hammers (4.6.1, 4.6.2) while the shift wheel (4.7) can be rotated in steps of 90° via said control wheel (4.10).

7. Mechanism according to claim 1, characterised in that said control mechanism (8) of the gear mechanism (4) includes a pawl (8.4.3) adapted to temporarily mesh with said control wheel (4.10) in order to rotate it in such a way that the shift wheel (4.7) is rotated through an angle of 90°.

8. Mechanism according to claim 7, characterised in that said control mechanism (8) of the gear mechanism (4) includes two superimposed control elements (8.3, 8.4), the second element (8.4) holding at least said pawl (8.4.3) and the first element (8.3) holding at least two springs (8.3.4, 8.3.5) tensioning each pawl (8.4.3) against said control wheel (4.10) or preventing the contact between each pawl (8.4.3) and the corresponding control wheel (4.10), respectively, the action of these springs (8.3.4, 8.3.5) being determined by the relative positions of the two elements (8.3, 8.4).

9. Horological movement, more particularly chronograph movement, characterised in that it includes at least one gear mechanism according to claim 1.

10. Horological movement according to claim 9, characterised in that it includes a display gear train (3) with a display wheel and pinion having indicator wheels, one for the seconds (3.3a), one for the minutes (3.3b), and one for the hours (3.3c), and in that it includes three gear mechanisms according to claim 3 that are laterally arranged around the display wheel and pinion, and that have gear wheels (4.6a, 4.6b, 4.6c) meshing with the corresponding indicator wheels (3.3a, 3.3b, 3.3c).

11. Movement according to claim 10, characterised in that each clutch disc (4.3) of a gear mechanism (4) can be locked against all rotation with the aid of a chronograph control mechanism including clamps (6.8), one for each clutch disc (4.3), allowing said clutch disc (4.3) to be clamped or released.

12. Timepiece, more particularly chronograph, characterised in that it includes an horological movement according to claim 9.

13. Horological control mechanism (8), intended to be integrated into an horological movement and adapted to control the rotation of at least one control wheel (4.10) that can be rotated in a controlled way, characterised in that said control mechanism (8) includes two mobile, superimposed control elements (8.3. 8.4), the second element (8.4) holding at least one pawl (8.4.3) adapted to cooperate with one of said control wheels (4.10), so as to rotate it through a predetermined angle, and the first element (8.3) holding at least one pretensioning spring (8.3.4) tensioning each pawl (8.4.3) against said control wheel (4.10), and at least one holding spring (8.3.5) adapted to permit or break the contact between each pawl (8.4.3) and the corresponding control wheel (4.10), the action of these springs (8.3.4, 8.3.5) being determined by the relative positions of the two control elements (8.3, 8.4).

14. Mechanism according to claim 13, characterised in that in the rest position of the two control elements (8.3, 8.4), each holding spring (8.3.5) is engaged in a notch formed in the corresponding pawl (8.4.3), so as to prevent contact between this pawl (8.4.3) and the corresponding control wheel (4.10) while the pawl (8.4.3) is pretensioned toward this control wheel (4.10) by the corresponding one of said pretensioning springs (8.3.4); in that the first control element (8.3) includes a control spring (8.3.3) pushing against a pin (8.4.2) attached to the second control element (8.4) in such a way that a movement of the first control element (8.3) that is caused by manual or automatic actuation of the mechanism causes a movement of the second control element (8.4) in the same direction, but limited by a limiting element (8.5) struck by said second element (8.4) when its movement has attained a predetermined value, so that when the movement of the first control element (8.3) has exceeded said predetermined value, each holding spring (8.3.5) will be disengaged from said notch in the corresponding pawl (8.4.3) owing to the relative movements of the two control elements (8.3, 8.4), and allow each pawl (8.4.3) to temporarily contact said control wheel (4.10) and rotate it; and in that a return spring (8.6) pretensioning the second control element (8.4) in the direction opposite to said movement will return the two elements (8.3, 8.4) to their initial positions, thus causing rotation of the control wheel (4.10) through said predetermined angle, as soon as the manual or automatic actuation is relieved.

15. Mechanism according to claim 14, characterised in that each pawl (8.4.3) includes an eccentric (8.3.4.1) with a pin that is engaged into a recess arranged in a bridge of said horological movement, this recess having a shape adapted so that at the end of the return movement of the two control elements (8.3, 8.4), each pawl (8.3.4) is guided back to its initial position where it is once more gripped by the corresponding holding spring (8.3.5), and out of contact with the corresponding control wheel (4.10).

16. Mechanism according to claim 14, characterised in that the control spring (8.3.3), the pretensioning spring (8.3.4), and/or the actuating spring (8.3.5) are integral parts of the first control element (8.3).

17. Mechanism according to claim 14, characterised in that said control spring (8.3.3) is essentially Z-shaped, and is formed on an arm (8.3.2) of the first control element (8.3).

18. Mechanism according to claim 13, characterised in that the first and second control elements (8.3) consist of superimposed levers performing a translatory or pivoting movement, and holding a pawl (8.4.3) controlling a corresponding control wheel (4.10) located on one side of said levers.

19. Mechanism according to claim 13, characterised in that the first and second control elements (8.3, 8.4) consist of superimposed rings performing a rotatory movement, and holding at least one pawl (8.4.3) controlling at least one corresponding control wheel (4.10) located inside the circumference of these rings.

20. Mechanism according to claim 13, characterised in that the first control element (8.3) can be actuated by a push piece (8) linked to a shift element (8.1) that can be displaced axially, and in turn allows a shift lever (8.2) holding on its free end an actuating pin (8.2.1) to be pivoted by a pin going through these two pieces, said pin (8.2.1) being able to become engaged on an inclined plane formed in an actuating notch (8.3.1) located on said first control element (8.3) when said push piece (8) is pressed, in such a way that this element will perform a movement of predetermined value corresponding to the length of said inclined plane.

21. Mechanism according to claim 20, characterised in that said movement of predetermined value is a rotation through a predetermined angle or a translation through a predetermined distance.
